(19) United States
(12) Patent Application Publication
(10) Pub. No.: US 2009/0307058 A1
(43) Pub. Date: Dec. 10, 2009

(54) END USER INTERFACE CUSTOMIZATION AND END USER BEHAVIORAL METRICS COLLECTION AND PROCESSING

(75) Inventor: Patrick J. Murphy, Dublin, OH (US)

Correspondence Address: CALFEE HALTER & GRISWOLD, LLP, 800 SUPERIOR AVENUE, SUITE 1400, CLEVELAND, OH, 44114, US

(73) Assignee: BRAND THUNDER, LLC, Dublin, OH (US)

(21) Appl. No.: 12/478,410

(22) Filed: Jun. 4, 2009

Related U.S. Application Data
(60) Provisional application No. 61/058,729, filed on Jun. 4, 2008.

(51) Int. Cl. G06Q 30/00; G06Q 99/00

(52) U.S. Cl. 705/10; 705/14.53

(57) ABSTRACT

A method and a system for customizing an end user interface for a computer application is provided. The method includes developing a customized user interface for the computer application, wherein the customized user interface includes features that provide content associated with a brand, and providing updated content to the customized user interface. The system includes a host server operable to download and update the customized end user interface.

### CROSS-REFERENCE TO RELATED APPLICATIONS

This application claims priority to, and any other benefit of, U.S. Ser. No. 61/058,729, filed Jun. 4, 2008, the contents of which are fully incorporated herein by reference.

### BACKGROUND

A typical computer system includes hardware and software that allows a user to perform tasks such as communicating with other computer users, accessing various computer resources, and viewing, creating, or otherwise manipulating electronic content. The system includes various input/output (I/O) devices (mouse, keyboard, display) and a general purpose computer having a central processor unit (CPU), an I/O unit, and a memory that stores data and various programs such as an operating system, and one or more application programs. The computer system also typically includes non-volatile memory (e.g., flash RAM, a hard disk drive, and/or a floppy disk or other removable storage media) and a communications card or device (e.g., a modem or network adapter) for exchanging data with a network via a communications link (e.g., a telephone line, broadband, or wireless access point). Some of the most common uses of a computer system are to access the Internet and manage or play various media content, such as audio or video files.

With the popularization of the Internet, web browsers used for Internet surfing are installed on almost all computers. The web browser is a kind of program which presents information transmitted from a server computer in a viewable form according to a communication protocol (e.g., HTML) via the display of the computer system. Many information providers display content, such as sites or advertisements, in a part of the web browser when users access a server computer.

### SUMMARY

A method and a system for customizing an end user interface for a computer application is provided. In one embodiment, the method includes: developing a customized user interface for the computer application, wherein the customized user interface includes features that provide content associated with a brand; providing the customized user interface to an end user of the computer application, wherein the end user installs the customized user interface on a computer system and uses the computer application with the customized user interface; and providing updated content to the customized user interface, wherein the updated content is associated with the brand.

In another embodiment, the system includes: a host server interfaced with a network, the host server operable to exchange information with devices on the network; and a customized end user interface for the computer application that can be downloaded from the host server to an end user computer system interfaced with the network in response to a download request, the end user computer system operable to exchange information with devices on the network, and wherein the customized end user interface includes features that provide content associated with a brand, and content is downloaded from the host server to the end user computer system.

Other embodiments of the invention are more fully described below. This summary does not limit the scope of the claims set forth below in any way. The words of the claims have all of their full ordinary meaning.

### DRAWINGS

These and other features, aspects, and advantages of the present invention will become better understood with regard to the accompanying drawings, following description, and appended claims.

FIG. 1 is an exemplary embodiment of a theme applied to a web browser;

FIG. 2 is a flow chart of an exemplary embodiment of a process to customize an end user interface and collect and process end user behavioral metrics;

FIG. 3 is a block diagram of an embodiment of an exemplary system for managing the end user interface customization or theme and behavioral metrics collection and processing;

FIG. 4 is a block diagram of an embodiment of an exemplary system for self management and enhancement of themes by clients;

FIG. 5 is a block diagram of an embodiment of an exemplary system to collect end user web behavior and metric data and make them available via a web based tool; and

FIG. 6 is an embodiment of an exemplary screen shot of a web page that may be used in conjunction with collecting and processing of metrics and other end user data.

### DESCRIPTION

The following paragraphs include definitions of exemplary terms used within this disclosure. Except where noted otherwise, variants of all terms, including singular forms, plural forms, and other affixed forms, fall within each exemplary term meaning. Except where noted otherwise, capitalized and non-capitalized forms of all terms fall within each meaning.

“Comprising,” “containing,” “having,” and “including,” as used herein, except where noted otherwise, are synonymous and open-ended. In other words, usage of any of these terms (or variants thereof) does not exclude one or more additional elements or method steps from being added in combination with one or more delineated elements or method steps.

“Computer application,” as used herein includes, but is not limited to, is any tool that functions and is operated by means of a computer, with the purpose of supporting or improving the computer or software user's work or interface experience. In other words, it is the class of computer software that employs the capabilities of a computer directly and thoroughly to a task that the user wishes to perform. In this context, “computer application” refers to both the application software and its implementation.

“Computer communication,” as used herein includes, but is not limited to, a communication between two or more computer components and can be, for example, a network transfer, a file transfer, an applet transfer, an e-mail, a hypertext transfer protocol (HTTP) message, a datagram, an object transfer, a binary large object (BLOB) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, any other current or subsequent communication system, and so on.

“Computer component,” as used herein includes, but is not limited to, a computer-related entity, either hardware, firmware, software, a combination thereof, or software in execution. For example, a computer component can be, but is not limited to being, a processor, an object, an executable, a process running on a processor, a thread of execution, a program and a computer. By way of illustration, both an application running on a server and the server can be computer components. One or more computer components can reside within a process or thread of execution and a computer component can be localized on one computer or distributed between two or more computers.

“Operable connection” (or a connection by which entities are “operably connected”), as used herein includes, but is not limited to, a connection in which signals, physical communication flow, or logical communication flow may be sent or received. Usually, an operable connection includes a physical interface, an electrical interface, or a data interface, but an operable connection may include differing combinations of these or other types of connections sufficient to allow operable control.

“Operative communication,” as used herein includes, but is not limited to, a communicative relationship between devices, logic, or circuits. Direct and indirect electrical, electromagnetic, and optical connections are examples of connections that facilitate operative communications. Two devices are in operative communication if an action from one causes an effect in the other, regardless of whether the action is modified by some other device. For example, two devices in operable communication may be separated by one or more of the following: i) amplifiers, ii) filters, iii) transformers, iv) optical isolators, v) digital or analog buffers, vi) analog integrators, vii) other electronic circuitry, viii) fiber optic transceivers, ix) Bluetooth communications links, x) IEEE 802.11 communications links, xi) satellite communication links, and xii) other wireless communication links. As an example, two devices not directly connected to each other, but both capable of interfacing with a third device, e.g., a central processing unit (CPU), are in operative communication.

“Or,” as used herein, except where noted otherwise, is inclusive, rather than exclusive. In other words, “or” is used to describe a list of alternative things in which one may choose one option or any combination of alternative options. For example, “A or B” means “A or B or both” and “A, B, or C” means “A, B, or C, in any combination or permutation.” If “or” is used to indicate an exclusive choice of alternatives or if there is any limitation on combinations of alternatives, the list of alternatives specifically indicates that choices are exclusive or that certain combinations are not included. For example, “A or B, but not both” is used to indicate use of an exclusive “or” condition. Similarly, “A, B, or C, but no combinations” and “A, B, or C, but not the combination of A, B, and C” are examples where certain combinations of alternatives are not included in the choices associated with the list.

“Processor,” as used herein includes, but is not limited to, one or more of virtually any number of processor systems or stand-alone processors, such as microprocessors, microcontrollers, central processing units (CPUs), distributed processors, paired processors, and digital signal processors (DSPs), in any combination. The processor may be associated with various other circuits that support operation of the processor, such as random access memory (RAM), read-only memory (ROM), programmable read-only memory (PROM), erasable programmable read-only memory (EPROM), clocks, decoders, memory controllers, or interrupt controllers, etc. These support circuits may be internal or external to the processor or its associated electronic packaging. The support circuits are in operative communication with the processor. The support circuits are not necessarily shown separate from the processor in block diagrams or other drawings.

“Software,” as used herein includes, but is not limited to, one or more computer readable or executable instructions that cause a computer or another electronic device to perform functions, actions, or behave in a desired manner. The instructions may be embodied in various forms such as routines, flowcharts, algorithms, modules or programs including separate applications or code from dynamically linked libraries. Software may also be implemented in various forms such as a stand-alone program, a function call, a servlet, an applet, instructions stored in a memory, part of an operating system, or other types of executable instructions. It will be appreciated by one of ordinary skill in the art that the form of software is dependent on, for example, requirements of a desired application, the environment it runs on, or the desires of a designer/programmer or the like.

“Software component,” as used herein includes, but is not limited to, a collection of one or more computer readable or executable instructions that cause a computer or other electronic device to perform functions, actions or behave in a desired manner. The instructions may be embodied in various forms like routines, algorithms, modules, methods, threads, or programs. Software components may be implemented in a variety of executable or loadable forms including, but not limited to, a stand-alone program, a servlet, an applet, instructions stored in a memory, and the like. Software components can be embodied in a single computer component or can be distributed between computer components.

“Theme,” as used herein includes, but is not limited to, a package containing graphical appearance details and features associated with a brand, used to customize the look and functionality of the user interface of a computer application, such as, for example, a web browser, media player, or other computer application a user may view or run on a computer system. Essentially, the theme brands a computer application. Themes for individual applications are often referred to as “skins,” but may include features not ordinarily associated with skins. A theme may include, for example, customized skins, functionality, extensions, and advertising embedded into a computer application, all associated with the brand. Themes are often used to change the appearance and settings of an application collectively, which makes them much more cohesive than allowing the user to set each option individually.

“Widget,” as used herein includes, but is not limited to, portable software that can be installed and executed within any separate HTML-based web page by an end user without requiring additional compilation. Widgets often take the form of on-screen tools, such as, for example, clocks, event countdowns, auction-tickers, stock market tickers, flight arrival information, and weather.

The following table includes long form definitions of exemplary acronyms, abbreviations, and labels for variables and constants in mathematical or logical expressions used within this disclosure. Except where noted otherwise, variants of all acronyms, including singular forms, plural forms, and other affixed forms, fall within each exemplary acronym meaning. Except where noted otherwise, capitalized and non-capitalized forms of all acronyms fall within each meaning.

| Acronym | Long Form |
|---|---|
| HTML | Hypertext markup language |
| HTTP | Hypertext transfer protocol |
| IP | Internet protocol |
| LAN | Local area network |
| PROM | Programmable read-only memory |
| RAM | Random access memory |
| ROM | Read-only memory |
| RSS | Really simple syndication |
| SQL | Standard query language |
| URL | Uniform resource locator |

Customized content and communication channels may be established between clients and end users via themes built into computer applications, such as web browsers, media players and various widgets. A client is the promoter or owner of a theme, brand, or a theme used for promoting a particular brand. A host is the computer manager or facilitator that controls or provides the themes for clients over computer networks or servers.

A computer application with a theme applied, or a themed computer application, may add features to the computer application that allow clients to continuously communicate with and provide content to end users while they are using the computer application. Clients may be interested in promoting a particular brand to end users and encouraging more views and visits to their associated sites. End users may be interested in customizing a particular computer application with content associated with a particular brand. A host may facilitate the creation, installation, and maintenance of the theme and its contents.

A theme can transform the computer application into a branded experience, immersing the end user with customized content related to the theme or brand. Themes may incorporate brand elements, such as, for example, fonts, color schemes, and icons, into the decoration and navigation of the computer application. The end user may choose to apply a theme to a particular computer application because the graphical appearance package of the theme may be customized with content aligned with a particular interest of the end user, such as, for example, the end user's favorite organization, product or special interest, ranging from movies, music, and sports to consumer goods. Themes may also be customized with pictures or images of anything, such as, for example, personal photographs.

Exemplary themes may include visual representations of the brand item as well as functionality, such as, for example, embedded news feeds, media players, chat tools, alerts, notifications, and site links, also known as “hook” features, that present the end user with branded information and links. The computer application may be thought of as “taken over” by the theme. This enables the host, client, or even end user to control the computer application's user interface and display engine and embed additional functionality, the “hooks”. Hooks such as media players, RSS feeds, advertising, and multiple revenue generating tools may be built into the computer application while delivering customized branded content and messaging directly to the brand's audience of end users. The theme may also include an e-commerce component, such as, for example, with sports themes, the theme may include features associated affiliates, partners, merchandise, and ticket sales.

Other exemplary themes may include user engagement tools, such as, for example, polls, real-time chat, and buddy list integration, sharing and distribution of themes to other users, and enabling the computer application to alert or notify the end user of certain brand-related events.

A computer application with a theme may benefit clients by allowing them to target advertisements to a focused audience of end users, delivering content more relevant and readily accepted. In addition, the hook features may help create a deeper engagement with end users, possibly resulting in more page views per visit, which may result in a more valuable site.

To facilitate the branding of computer applications using themes, a host system may provide various services to the client and end user. For example, in one embodiment, the host system may provide software or computer components to install the theme on and un-install the theme from the end user's computer system. In another embodiment, the host may provide custom development of the theme to integrate client tools into the computer application, such as, for example, chat, video, personalization, real-time information, and dynamic advertising. In another embodiment, the host may also allow the client or end user to control how content is rendered as well as what is rendered. In yet another embodiment, the host may takeover a default search box within a computer application, such as a browser, and control the selection of specific search partners, such as, for example, Google, Yahoo, and ASK.

Other embodiments may include individual software or computer components that set start pages (default page that appears when browser is started), bookmarks (add a folder of key bookmarks into user's browser bookmarks), search engines, or embed a media player, for example, when a client may have audio-video media to extend to end users, or full-custom builds of the computer application, such as a web browser.

In another embodiment, the host may provide a self management environment for clients to proactively control various features or content, such as, for example, sponsorships, advertising, and reporting via a management server. In yet another embodiment, a data collection and mining system may be provided for customer behavior insight, which may enhance advertisement targeting. Other embodiments may include other host services, such as producing new advertisement inventory for clients and advertisers within themes, an outlet for a client's digital assets, such as, for example, news feeds and video, and a system to allow a client or end user to build their own theme. The host may also allow users to build their favorite versions of the theme and share them with other users.

In other embodiments, metrics may be provided to clients or third parties. Metrics are relevant data or measurables relating to the end user's use of a client theme or computer application associated with a client's theme. The host may provide clients with various information, such as, for example, monthly reporting detailing download counts, download sources, and traffic volume driven back to the client's site via the various features, such as buttons and links, embedded within the theme. By monitoring metrics and usage on a frequent basis, clients can make adjustments and tweaks to the theme as needed to ensure relevancy to the end user as well as maximizing the theme features. In another embodiment, the host may gather behavior data or metrics, which can be mined for learning by clients and third parties.

In another embodiment, the host may offer bundling of third party applications and or programs during installation of the theme. The third parties or clients may be required to pay the host for each install of the bundled product.

Although the embodiments described below relate primarily to a web browser as an exemplary computer application, other embodiments include other computer applications, such as, for example, media players and widgets.

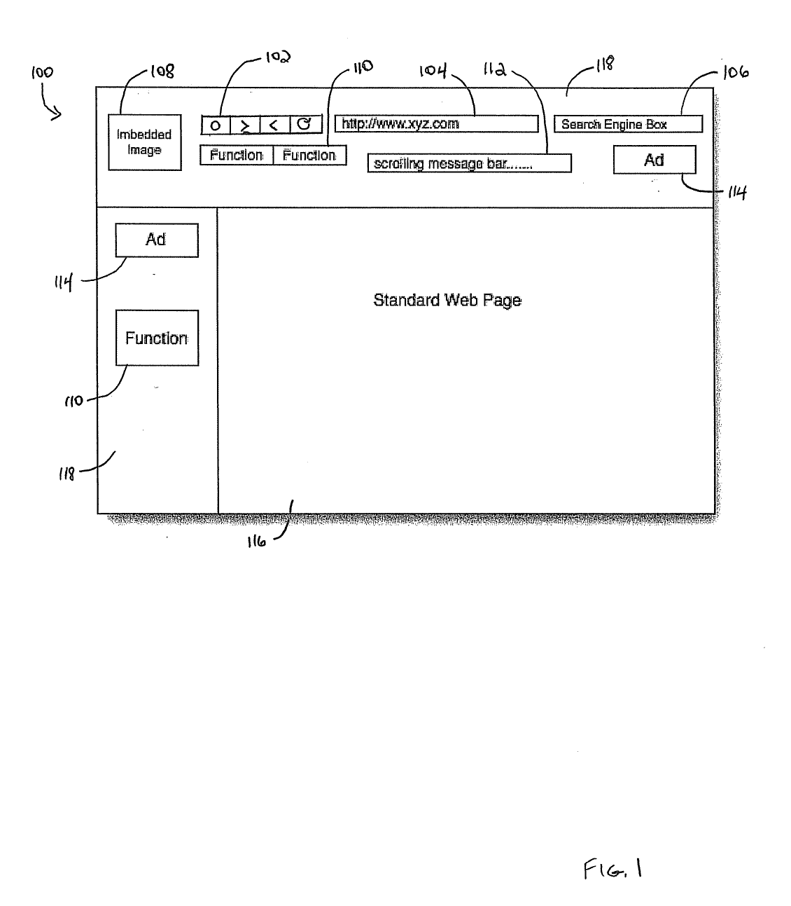

An exemplary embodiment of a theme is shown in FIG. 1, applied to a web browser 100. Although the exemplary theme in FIG. 1 is shown applied to the web browser 100, in other embodiments the theme can be applied to other computer applications, such as, for example, media players and widgets. Exemplary web browsers include Firefox, Safari, and Internet Explorer. The web browser 100 is shown with a theme that includes customized content for one or more specific brands. The web browser 100 may receive the theme via a download or installation tool. Once the theme is installed, it can “overlay” the existing computer application (such as the web browser 100), but the theme may also be downloaded as a full computer application, pre-configured and customized with the theme, including, for example, extensions and advertising, built-in. After a theme is applied to a computer application, native features of the computer application may be maintained. For example, referring to the web browser 100 of FIG. 1, native features of the browser, such as standard navigational buttons 102, a URL bar 104, and a search engine box 106, may continue to be features of the web browser 100 after the theme is applied.

Still referring to FIG. 1, when the theme overlays an existing computer application, the theme may add features that customize certain elements, such as how the application renders content or information, the appearance and function of the application, embedding advertising and sponsorships, and other design changes. For example, the web browser 100 may include one or more embedded images 108 from a partner or client organization that is associated with the brand. The web browser 100 may also include one or more embedded functions 110, such as, for example, links and multimedia content. The web browser 100 may include a scrolling message bar 112 with customized scrolling information, such as news or brand specific alerts. The web browser 100 may also include one or more advertisements 114, such as customized advertising aligned with the brand and targeted for the end user. The web browser 100 is also shown with a standard web page 116 displayed. The web browser 100 may also include background graphics 118 associated with the brand, including, for example, colors, icons, logos, and other imagery.

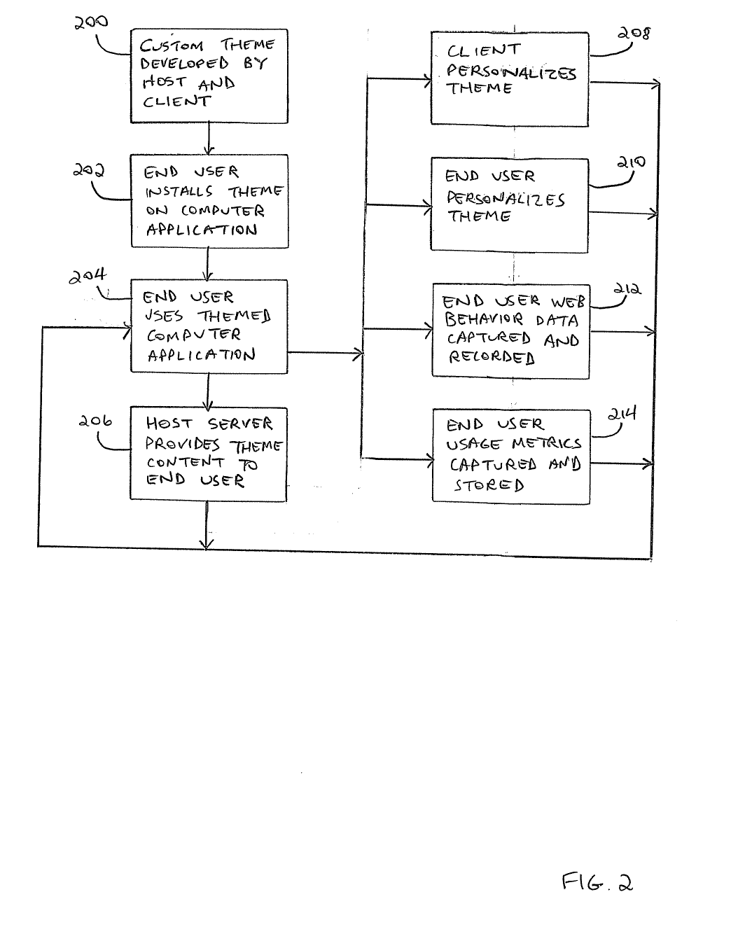

The block diagram in FIG. 2 represents an exemplary embodiment of how to customize an end user interface (theme) and collect and process end user behavioral metrics. The block diagram may not portray the organization of specific software, software components, logic, or programming code. Although FIG. 2 shows a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, or commands may be added to the logical flow for purposes of enhanced utility, accounting, performance, measurement, troubleshooting, and the like. It is understood that all such variations are within the scope of the present invention.

In FIG. 2, the logical flow for how to customize an end user interface with a theme and collect and process end user behavioral metrics may begin in block 200 where the customized user interface or theme for the computer application is developed by the host or client. The computer application may be, for example, the web browser 100.

After the theme for the computer application is developed in block 200, the logical flow may proceed to block 202, where the end user may install the theme on a computer application in the end user's computer system. The theme may be provided via a download from a server or provided on a computer readable medium.

Once the theme is installed in block 202, the logical flow may proceed to block 204, where the end user uses the themed computer application, such as the web browser 100. The end user may use the themed computer application for the original purpose of the computer application, albeit with the features provided by the theme. For example, the themed web browser 100 may be used for browsing the internet using the native features of the browser, such as the standard navigational buttons 102, the URL bar 104, and the search engine box 106. But the themed web browser 100 may also include additional features provided by the theme, such as the images 108, functions 110, scrolling message bar 112, advertisements 114, and background graphics 118 referenced in FIG. 1.

As the end user uses the themed computer application in block 204, the logical flow may proceed to block 206, where the host server may provide theme content to the end user via the features of the themed computer application. The content presented in the theme features may be updated regularly by the host or the client.

As the end user uses the themed computer application in block 204, the logical flow may also proceed to block 208, where the client may personalize or customize the features or contents of the theme.

As the end user uses the themed computer application in block 204, the logical flow may also proceed to block 210, where the end user may personalize or customize the features of the theme.

As the end user uses the themed computer application in block 204, the logical flow may also proceed to block 212, where end user web behavior data may be captured and recorded.

As the end user uses the themed computer application in block 204, the logical flow may also proceed to block 214, where end user usage metrics may be captured and stored.

After the host server provides theme content to the end user in block 206, the client personalizes the theme in block 208, the end user personalizes the theme in block 210, end user web behavior data is captured and recorded in block 212, or end user usage metrics are captured and stored in block 214, the logical flow may proceed to block 204 where the end user may continue to use the themed computer application.

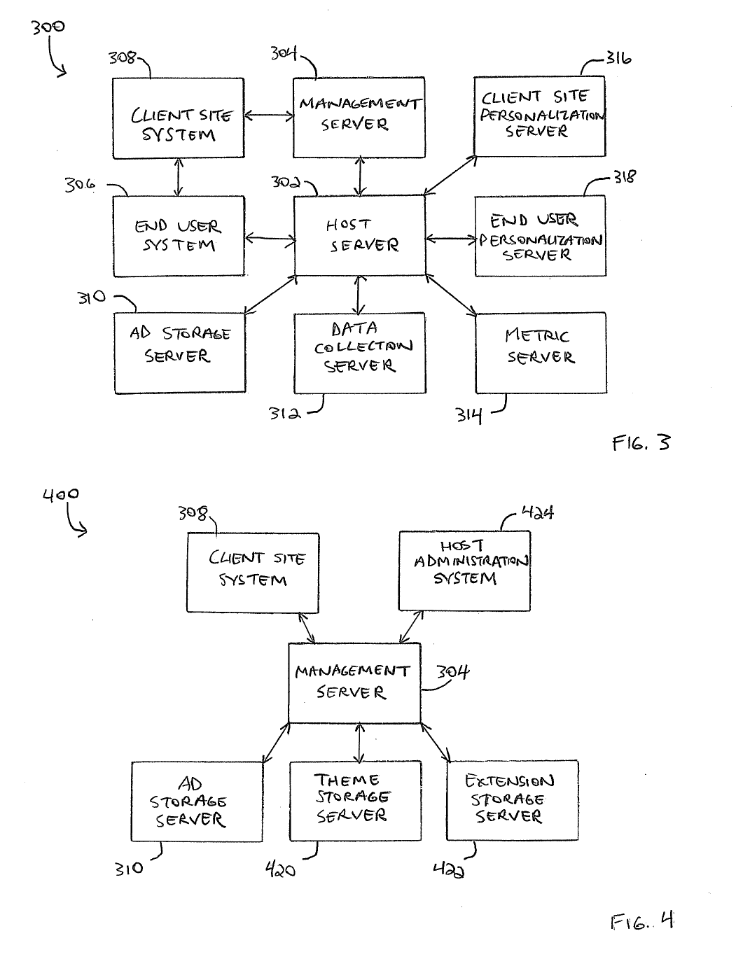

The block diagram of FIG. 3 shows an embodiment of an exemplary system 300 for managing the end user interface customization or theme and behavioral metrics collection and processing. The system 300 is centered on a host server 302. The host server 302 facilitates the creation, installation, and ongoing servicing of themes. The host server 302 is shown as one block but may be a collection of more than one operatively connected servers with computer communication capability. The host server 302 is operatively connected to a management server 304. In one embodiment, the host server 302 may allow for server-side updates and management, which may allow the host to manage theme updates from the host server 302, instead of being controlled by the end user. This feature may allow for dynamic updates, where no user intervention is required, and may include the ability for advertiser “takeovers.” The management server 304 allows clients to self-manage and enhance themes and is shown with additional operative communications in FIG. 4 and is discussed in more detail below.

Again referring to FIG. 3, an end user computer system 306 may be operatively connected to the host server 302 or a client site computer system 308. Although the end user computer system 306 and the client site computer system 308 are each shown as one block, they may include more than one suitable computer system. Via the operative connections to the host server 302, the client site computer system 308, or a computer readable medium, the end user may download and install the theme to the end user computer system 306.

As mentioned above, customized or themed computer applications may be built on an existing platform, such as, for example Firefox or Internet Explorer web browsers. In one embodiment, when the host provides a customized theme that can build on the platform, it also can provide software components for the un-installation of, as well as the installation of, and ongoing servicing and maintenance of themes. In this manner, the native computer application may be restored to its original configuration and appearance when the theme overlay is uninstalled. During these processes, the theme bundle loading sequence may utilize silent restart multiple times and may set new defaults for theme, extensions and search. The theme bundle un-install may utilize a one-click uninstall process.

The host server 302 is also in operative communication with an ad storage server 310. The host server 302 can provide brand related content to the end user computer system 306, such as, for example, contextual advertisements displayed in a feature of the theme. Advertisements may be stored on the ad storage server 310 and accessed as required by the host server 302.

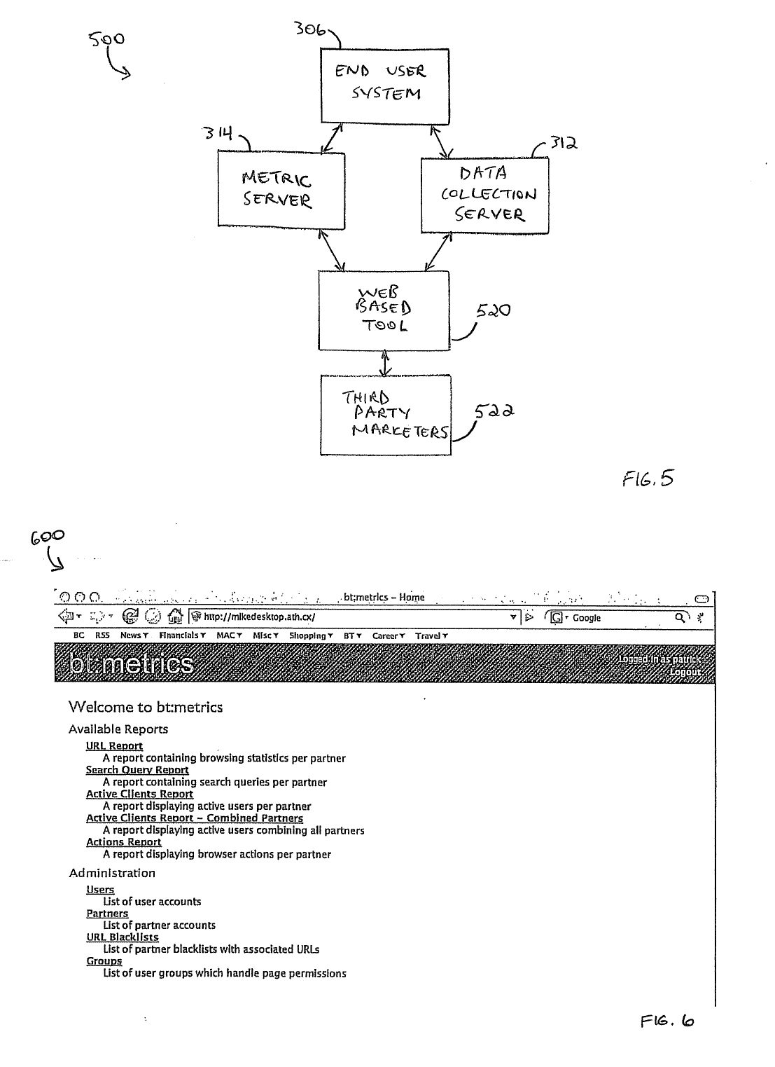

Once an end user installs a theme on a computer application of the end user computer system 306, the host server 302 may capture very unique metrics and usage behavior data associated with the end user using the end user computer system 306. The host server 302 is in operative communication with a data collection server 312 and a metric server 314. End user web behavior data are captured and recorded on the data collection server 312 and end user usage metrics are captured and stored on the metric server 314. The system to collect user web behavior and metric data and make them available via a web based tool is shown with additional operative communications in FIG. 5 and is discussed in more detail below.

The host server 302 is also in operative communication with a client site personalization server 316 and an end user personalization server 318. To encourage downloads of the themes, the host may provide the client site personalization server 316 and the end user personalization server 318 to allow for and offer custom elements for each theme to clients and end users. Personalizations or customizations can include, for example, custom images, localization, individual color palettes, and tags for content search. Client customizations may be made using any suitable client site system 308 through the management server 304 and host server 302 and stored in the client site personalization server 316. End user permitted customizations are made using any suitable end user system 306 and stored in the end user personalization server 318.

The block diagram of FIG. 4 shows an embodiment of an exemplary system 400 for self management and enhancement of themes by clients. In one embodiment, the system 400 may allow for self-management of all browser theme features and content. This may include, for example, managing advertising, images, and URLs. The system 400 may also include a reporting component (not shown).

The management server 304 facilitates allowing clients to self-manage and enhance themes and is shown in operative communication with the client site system 308. The management server 304 may allow for advertising placement, measurement, and reporting within the themes. The client, using a web browser and any suitable client site system 308 may log into the management server 304. The management server 304 may require appropriate log in credentials, such as a client user ID and password. Once logged in, the client can review and revise existing themes. Advertisements are available to the client via the operative connection between the management server 304 and the ad storage server 310, either directly or through the host server 302, as shown in FIG. 3. The ad storage server 310 maintains all advertising inventory for use in all client themes.

FIG. 4 also shows the management server 304 in operable communication with a theme storage server 420. The management server 304 accesses the theme storage server 420 for retrieval and storage of themes during theme changes made by the client. The theme storage server 420 maintains all of the themes for host clients, including all theme elements, which may be mainly graphical in nature. Similarly, the management server 304 is in operable communication with an extension storage server 422. Extensions may be used to provide for or embed a theme with functional features, such as, for example, one or more media players, buttons, scrolling feeds, login capabilities, search tools, interactivity, and proactive notifiers. The management server 304 accesses the extension storage server 422 for retrieval and storage of extensions during theme changes made by the client. The extension storage server 422 maintains all extensions for host partners, including extensions which provide, for example, usability improvements, functionality, unique tools, and interactivity.

In addition, FIG. 4 shows the management server 304 in operable communication with a host administration system 424. Although the management server 304 can be accessed by clients, host administrators can also manage advertisements, themes, and extensions across multiple client installations, using any suitable computer system as the host administration system 424.

The block diagram of FIG. 5 shows an embodiment of an exemplary system 500 to collect end user web behavior and metric data and make them available via a web based tool. The system 500 collects end user computer application behavior, such as, for example, web sites visited and search terms, as well as general usage metrics, which can be made available after an end user has installed a theme. In one embodiment, the system 500 may also allow for secure transmission and storage of all data and provide a process for mining and reporting on this data, for example, by host administration staff, clients, and third party firms.

FIG. 5 shows the end user system 306 in operative communication with the metric server 314 and the data collection server 312. End user data, includes, for example, sites visited, shopping history, queries, and search queries by the end user using the themed end user system 306. End user data are recorded and stored in the host's metric server 314 and the data collection server 312. The metric server 314 may include any suitable software to store, process requests, and analyze end user information. The data collection server 312 may include any suitable software to store and analyze end user web behavior.

The metric server 314 and the data collection server 312 are also shown in operable communication with a web based tool 520. The web based tool 520 may provide subscription based access to query marketing data stored in the metric server 314 or the data collection server 312 using any suitable security and report processing software. The web based tool 520 may be in operable communication with third party marketers 522. The third party marketers 522 may be provided access, for example, by paying for a subscription, to end user data metrics and web user behavior. This may be done via standardized report queries to the web based tool 520 using any suitable computer system. In another embodiment, the host may provide functionality to build a database of data consisting of, for example, search queries, URLs, and IP addresses, segmented by partner type.

FIG. 6 shows an embodiment of an exemplary screen shot 600 of a web page of the management server 304 that may be used in conjunction with collecting and processing of metrics and other end user data.

While the invention is described herein in conjunction with one or more exemplary embodiments, it is evident that many alternatives, modifications, and variations will be apparent to those skilled in the art. Accordingly, exemplary embodiments in the preceding description are intended to be illustrative, rather than limiting, of the spirit and scope of the invention. More specifically, it is intended that the invention embrace all alternatives, modifications, and variations of the exemplary embodiments described herein that fall within the spirit and scope of the appended claims or the equivalents thereof. Any element in a claim that does not explicitly state “means for” performing a specified function, or “step for” performing a specific function, is not to be interpreted as a “means” or “step” clause as specified in 35 U.S.C. § 112, ¶ 6. In particular, the use of “step of” in the claims herein is not intended to invoke the provisions of 35 U.S.C. § 112, ¶ 6. Further, the description of the embodiments above does not limit the scope of the claims in any way and the language of the claims has all of its full ordinary meaning.

1. A method of customizing an end user interface of a computer application, comprising the steps of:
developing a customized user interface for the computer application, wherein the customized user interface includes features that provide content associated with a brand;
providing the customized user interface to an end user of the computer application, wherein the end user installs the customized user interface on a computer system and uses the computer application with the customized user interface; and
providing updated content to the customized user interface, wherein the updated content is associated with the brand.

2. The method of claim 1, wherein the features of the customized user interface comprise at least one of images, colors, functions, and advertisements associated with the brand.

3. The method of claim 1, further comprising the step of:
allowing a client to modify the customized user interface, wherein the client is an organization associated with the brand.

4. The method of claim 1, further comprising the step of:
allowing the end user to modify the customized user interface.

5. The method of claim 1, further comprising the steps of:
capturing data associated with the usage of the computer application by the end user; and
recording the data associated with the usage of the computer application by the end user.

6. The method of claim 5, further comprising the step of:
providing client or third party access to the data associated with the usage of the computer application by the end user.

7. A system for hosting a customized end user interface of a computer application through a network, comprising:
a host server interfaced with the network, the host server operable to exchange information with devices on the network; and
a customized end user interface for the computer application that can be downloaded from the host server to an end user computer system interfaced with the network in response to a download request, the end user computer system operable to exchange information with devices on the network, and wherein the customized end user interface includes features that provide content associated with a brand, and content is downloaded from the host server to the end user computer system.

8. The system of claim 7, further comprising:
an end user personalization server interfaced with the network, the end user personalization server operable to exchange information devices on the network, wherein changes to the customized end user interface by an end user are stored on the end user personalization server.

9. The system of claim 7, further comprising:
an ad storage server interfaced with the network, the ad storage server operable to exchange information with devices on the network, wherein advertisements are stored on the ad storage server.

10. The system of claim 7, further comprising:
a client computer system interfaced with the network, the client computer system operable to exchange information with devices on the network, wherein the customized end user interface for the computer application is downloaded from the client computer system to the end user computer system in response to a download request.

11. The system of claim 10, further comprising:
a management server interfaced with the network, the management server operable to exchange information with devices on the network, wherein the management server controls access and changes to the customized end user interface by a client.

12. The system of claim 11, further comprising:
a client personalization server interfaced with the network, the client personalization server operable to exchange information with devices on the network, wherein changes to the customized end user interface by the client are stored on the client personalization server.

13. The system of claim 11, further comprising:
an ad storage server interfaced with the network, the ad storage server operable to exchange information with devices on the network, wherein advertisements are stored on the ad storage server.

14. The system of claim 11, further comprising:
a theme storage server interfaced with the network, the theme storage server operable to exchange information with devices on the network, wherein customized end user interfaces are stored on the theme storage server.

15. The system of claim 11, further comprising:
an extension storage server interfaced with the network, the extension storage server operable to exchange information with devices on the network, wherein extensions are stored on the extension storage server.

16. The system of claim 7, further comprising:
a host administration computer system interfaced with the network, the host administration computer system operable to exchange information with devices on the network, wherein the host administration computer system controls access and changes to the customized end user interface by a host administrator.

17. The system of claim 7, further comprising:
a data collection server interfaced with the network, the data collection server operable to exchange information with devices on the network, wherein web behavior of an end user is stored on the data collection server; and
a metric server interfaced with the network, the metric server operable to exchange information with devices on the network, wherein usage metrics of the end user are stored on the metric server.

18. The system of claim 17, further comprising:
a data access program for controlling access to data stored on the data collection server or the metric server, wherein the data access program resides on a device interfaced with the network.

19. The system of claim 18, further comprising:
a third party computer system interfaced with the network, the third party computer system operable to exchange information with devices on the network, wherein a third party may access the data stored on the data collection server or the metric server using the data access program and the third party computer system.

20. The system of claim 7 wherein the host server controls a plurality of customized end user interfaces for a plurality of clients.
